(19) United States
(12) Patent Application Publication
(10) Pub. No.: US 2021/0086116 A1
(43) Pub. Date: Mar. 25, 2021

(54) HIGH BURST STRENGTH WET-LAID NONWOVEN FILTRATION MEDIA AND PROCESS FOR PRODUCING SAME

(71) Applicant: Ahlstrom-Munksjö Oyj, Helsinki (FI)

(72) Inventors: Jesse Shim, Daegu Metropolitan City (KR); Jessica Lee, Daegu Metropolitan City (KR); Ryan Kwon, Daegu (KR); Matthew Jeon, Daegu (KR); Lani Lee, Daegu (KR)

(73) Assignee: Ahlstrom-Munksjö Oyj, Helsinki (FI)

(21) Appl. No.: 17/115,184

(22) Filed: Dec. 8, 2020

Related U.S. Application Data
(63) Continuation-in-part of application No. 17/048,390.
(60) Provisional application No. 62/658,419, filed on Apr. 16, 2018.

(51) Int. Cl. B01D 39/16; B01D 39/18; B01D 39/20

(52) U.S. Cl. CPC B01D 39/163; B01D 39/18; B01D 39/202; B01D 2239/0233; B01D 2239/0457; B01D 2239/1216; B01D 2239/064; B01D 2239/0636; B01D 2239/10; B01D 2239/1291; B01D 2239/1275; B01D 2239/0618

(57) ABSTRACT

Fibrous filtration media and method of making the same are provided. According to preferred embodiments, the filtration media includes an embossed wet-laid hot area-calendered nonwoven fibrous web which includes synthetic staple fibers, and from about 20 wt. % to about 80 wt. %, based on total weight of the fibrous web, of bicomponent staple fibers dispersed through the fibrous web. The fibrous web exhibits dry and wet burst strengths of greater than 5 bar, usually greater than 10 bar, and more preferably greater than about 12 bar, or even greater than about 15 bar in some embodiments.

### PRIORITIES AND CROSS REFERENCES

This application claims priority from U.S. Pat. No. 17,048,390 filed on 16 Oct. 2020, which is a 371 National Phase filing of International Application No. PCT/FI2019/050307 filed on 16 Apr. 2019, which claims priority from U.S. Provisional Application No. 62/658,419 filed on 16 Apr. 2018, the teachings of each of which are incorporated by reference herein in their entirety.

### FIELD

The embodiments disclosed herein relate generally to nonwoven filtration media for oil filters. In preferred forms, the nonwoven filtration media comprises a high density fibrous web (e.g., greater than about 0.20 g/cm³) which exhibits high dry and wet burst strength before and after hot oil aging (e.g., greater than about 5 bar, in some embodiments, greater than 10 bar). The high density fibrous web has relatively small Pore Size Range (e.g., less than about 30 μm; in some embodiments less than about 25 μm and, in some embodiments, less than about 20 μm) and optionally an embossing on one side.

### BACKGROUND

Oil filters intended for use in combustion engines conventionally comprise filter media with fibers obtained from wood pulp. Such wood pulp fibers are typically 1 to 7 millimeters long and 15 to 45 microns in diameter. Natural wood pulp has largely been the preferred raw material for producing filtration media due to its relatively low cost, processability, various mechanical and chemical properties, and durability in the end application. The filter media are pleated to increase filtration surface area transversally to the direction of the oil flow.

Conventional oil filters are typically comprised of a pleated sheet of filtration media and a backing structure. Conventional filtration media exhibit relatively low stiffness and have poor mechanical strength in terms of tensile strength and burst strength. The filtration media sheet of a conventional oil filter are therefore used together with a metal mesh or other type of support structure, which forms a backing for the filtration media sheet and assists in maintaining the pleat shape when used in the end application. Nevertheless, in view of the low mechanical strength, the filtration media sheet tends to burst over time on exposure to engine oil at the temperatures typically encountered in a combustion engine, e.g., temperatures of about 125° C. to about 135° C.

Although filtration media products that are produced largely with wood pulp are still an excellent choice for most automotive and heavy duty oil filtration applications, there is a growing market demand for oil filtration products that exhibit increased strength and durability over time as the media is exposed to the various chemical, thermal, and mechanical stresses of the end application environment. This demand stems from both harsher end application conditions that the media is exposed to as well as increasing demand for filtration media that can be safely used in the end application for increasingly longer amounts of time without rupturing or failing.

The long-standing and widely applied solution to this demand has been to incorporate some minor quantity of synthetic fiber, typically a polyester such as polyethylene terephthalate (PET), in an amount of about 5-20 wt. %. The result of fortifying the fiber furnish in this way is higher media strength as well as enhanced chemical and mechanical durability when the media is exposed to the end application environment, due to the superior chemical, thermal, and mechanical durability of the synthetic fibers themselves. By incorporating the synthetic PET fibers in these small amounts, the media performance is somewhat enhanced while still being able to produce a media that is both pleatable and self-supporting.

Spunbond nonwovens are now widely used for air filtration, such as dust collector filters, gas turbine intake air filters, powder coating filters and blasting filters, and for liquid filters such as pool and spa filters, waste-water filters, coolant filters since such applications require high dry and wet burst strength more than 10 bar. Such a high burst strength requirement can be met by the use of spunbond nonwovens as the filtration media but typically cannot be met by other types of filtration media, e.g., media formed of cellulosic fibers wet-laid nonwoven media and meltblown media.

None of the currently known prior art in the areas of air filters and/or fuel filtration media discloses a filter medium capable of forming a self-supporting oil filter when configured into a pleated structure and which would be capable of working properly at the harsh conditions in connection with an internal combustion engine (e.g., temperatures of up to 140° C. and in some cases up to 150° C.).

In fact, in general, filtration media containing a high percentage of synthetic fibers are not pleatable or self-supporting as such, and have to be co-pleated and reinforced with some sort of additional mechanical support layer, such as a plastic or wire mesh backing. Media made with high levels of synthetic fiber typically tend to exhibit drape and lack sufficient stiffness and rigidity causing the pleats to collapse without an additional support. Moreover, prior proposals for media containing high levels of synthetic fibers and corrugated by conventional methods cannot maintain a grooving pattern after exposure of the corrugated and/or pleated structure to hot oil, due to the thermal and mechanical properties of the synthetic fibers.

It would therefore be highly desirable if a fibrous filtration medium was provided that could be formed into a self-supporting oil filter when configured into a pleated structure and which would possess the necessary physical properties to be capable of working properly at the harsh conditions encountered in use with an internal combustion engine (e.g., temperatures of up to 140° C. and in some cases up to 150° C.). It is therefore towards fulfilling such desirable attributes that the embodiments disclosed herein are directed.

Additionally, it would be desirable if a fibrous filtration medium was provided having high hot oil aging resistance. That is to say that the media can retain its shape and pattern in harsh conditions such as those present in an oil filter for an internal combustion engine.

### Summary of Exemplary Embodiments

The filtration media in accordance with the embodiments disclosed herein includes an area-calendered wet-laid nonwoven fibrous web which possesses a high dry and wet burst strength of greater than 5 bar, usually greater than 10 bar, and more preferably greater than 12 bar or even greater than about 15 bar in some embodiments. After hot oil aging, the fibrous web retains a high dry burst strength of greater than 5 bar, usually greater than 10 bar. The fibrous web may also possess a stiffness of greater than 2000 mg in the machine direction (MD), more preferably greater than 2300 mg in MD, and most preferably greater than 2600 mg in MD, after hot oil aging. The calendered wet-laid nonwoven fibrous web may also comprise an embossing on one side of the fibrous filtration media.

The embodiments disclosed herein are realized by providing a wet-laid nonwoven fibrous web comprising between about 20 to about 80 wt. %, bicomponent staple fibers based on the total weight of the fibrous web, preferably symmetrical sheath-core type bicomponent staple fibers with the balance being other synthetic staple fibers, with the nonwoven web being subject to hot area calender bonding. The presence of at least 20 wt. % sheath-core type bi-component fibers permit area bonding to occur so as to achieve substantially less filtration “dead space” as compared to the point-calender bonding which is typically used for spunbond media. In contrast, if the amount of the bicomponent staple fibers is less than 20 wt. % based on the total weight of the fibrous web, it has been found that the fibrous web will not have the required strength to allow for a self-supporting media. A higher proportion of sheath-core type bi-component fibers and the homogenous dispersion of such fibers throughout the nonwoven wet-laid mat allows the filtration media of the embodiments disclosed herein to achieve at least comparable, and usually better, dry and wet burst strength than that of spunbond media which is composed of continuous filaments, even though the fibrous web of the present invention contains a mass of relatively short cut (e.g., 1˜24 mm) staple fibers with no continuous filaments.

These and other attributes of the various embodiments according to the invention will be better understood by reference to the following detailed descriptions thereof.

### BRIEF DESCRIPTION OF ACCOMPANYING DRAWINGS

Reference will be made to the accompanying drawings, wherein:

FIG. 1 is a scanning electron microscope (SEM) image of a cross-section of a conventional wet-laid fibrous web as taken along the thickness of such media;

FIG. 2 is a SEM image of a cross-section of a fibrous web in accordance with the embodiments disclosed herein as taken along the thickness of such media showing that the media contains thermally bonded binder fibers throughout the depth of the media which is believed to contribute to the high dry and wet burst strength that is exhibited thereby;

FIG. 3 is a SEM image of the surface of an inventive media; and

FIG. 4 is a diagrammatic view of the calendering process employed in accordance with an embodiment of the disclosed invention herein.

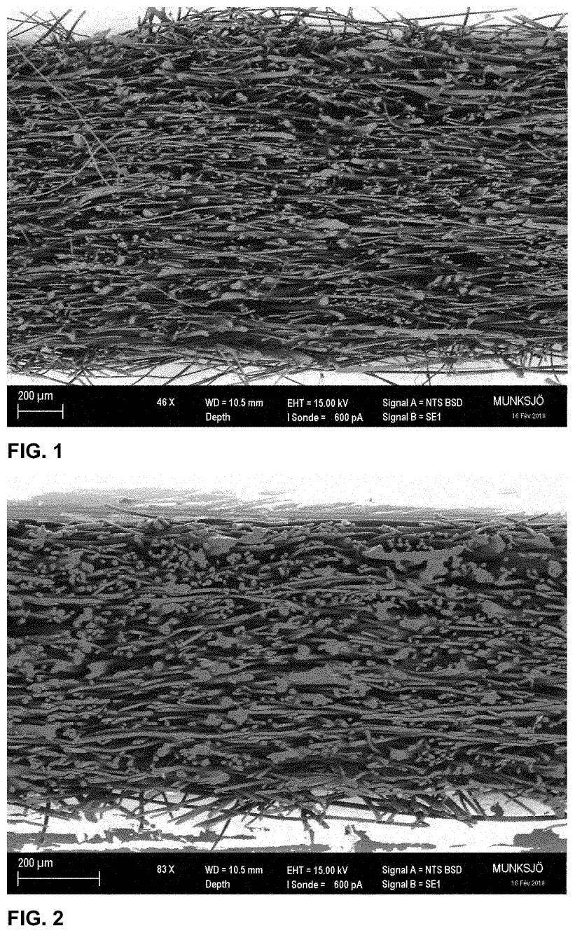

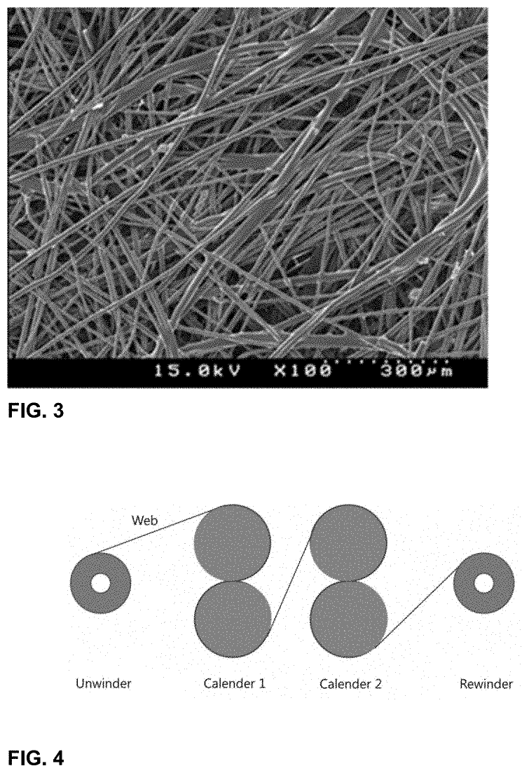

### DEFINITIONS

As used herein and in the accompanying claims, the terms below are intended to have the definitions as follows.

“Fiber” is a fibrous or filamentary structure having a high aspect ratio of length to diameter.

“Filament” denotes a fiber of extreme or indefinite length.

“Staple fiber” means a fiber which naturally possesses or has been cut or further processed to definite, relatively short, segments of definite or individual lengths.

“Fibrous” means a material that is composed predominantly of fiber and/or staple fiber.

The terms “non-woven”, “web” or “mat” refer to a collection of fibers and/or staple fibers in a mass of such fibers which are randomly interlocked, entangled and/or bound to one another so as to form a self-supporting structural element.

The terms “synthetic fiber” and/or “man-made fiber” refer to fibers made from fiber-forming substances including polymers synthesized from chemical compounds, modified or transformed natural polymer materials. Such fibers may be produced by conventional melt-spinning, solution-spinning, solvent-spinning and like filament production techniques.

A “cellulosic fiber” is a fiber composed of or derived from cellulose.

The term “thermoplastic” means a polymeric material which becomes pliable or moldable above a specific temperature and then returns to a solid state upon cooling.

The terms “embossed” and/or “embossing” refer to a raised and/or recessed relief pattern or design in a surface of the filtration media.

The term “downstream side” refers to a surface of the filtration media that is positioned in the filter element to be near the outlet of the flow in said filter element.

The term “filter element” refers to a device or arrangement comprising the filter media which may be pleated and is disposed between a pair of end caps so as to form a hollow cylinder. Other shapes and arrangements may also be possible.

The term “self supporting” refers to a media having sufficient strength/stiffness such that it can be converted to a pleated filter element without requiring additional supporting layers or backing structures.

The term “hot oil aging resistance” means that the media retains its shape and pattern even after aging in hot oil, and that filter elements comprising the media will not suffer any loss of shape or structure (e.g. please collapse or loss of embossed pattern).

### DETAILED DESCRIPTION

The calendered nonwoven wet-laid media of the embodiments disclosed herein may be in the form of 100% synthetic staple fibers, for example, a fibrous media comprised entirely of synthetic polymeric fibers, optionally containing other synthetic staple fibers (e.g., glass or other inorganic fibers). Thus, in preferred forms, the nonwoven media of the embodiments disclosed herein will be substantially (if not entirely) free of cellulosic or other natural staple fibers. In especially preferred forms, the calendered media of the embodiments disclosed herein will comprise a wet-laid nonwoven web consisting of 20-80% of bicomponent staple fibers with the remainder being other synthetic staple fibers, preferably other synthetic polymeric staple fibers.

### A. Bicomponent Staple Fibers

The nonwoven fibrous web according to the embodiments disclosed herein comprises a synthetic bicomponent staple fiber. As is known per se, the bicomponent staple fibers will have been formed by extruding polymer sources from separate extruders and spun together to form a single fiber. Typically, two separate polymers are extruded, although a bicomponent fiber may encompass extrusion of the same polymeric material from separate extruders with the polymeric material in each extruder having somewhat different properties (e.g., melting points). The extruded polymers are arranged in substantially constantly positioned distinct zones across the cross-section of the bicomponent fibers and extend substantially continuously along the length of the bicomponent fibers. The configuration of bicomponent fibers employed in the practice of the embodiments disclosed herein are preferably substantially symmetric sheath-core bicomponent fibers whereby the polymeric sheath completely surrounds and envelops the polymeric core at an area ratio of sheath to core of between about 25/75 to about 75/25, typically about between about 50/50 to about 70/30.

The bicomponent staple fibers which are preferably bicomponent polyethylene terephthalate (PET) staple fibers having a lower melting point PET sheath surrounding a higher melting point PET core. In preferred forms, the bicomponent PET staple fibers will include a PET sheath having a melting point of between about 120° C. to about 190° C., typically between about 140 to 190° C., more preferably between 150° C. to about 180° C., e.g., about 165° C. (+/−3° C.), and a PET core having a melting point that is at least about 50° C., typically at least about 75° C., e.g., about 100° C. (+/−5° C.) greater than the melting point of the PET sheath. The PET core of the bicomponent staple fibers may therefore have a melting point of between about 220° C. to about 280° C., typically between about 250° C. to about 270° C., e.g., about 260° C. (+/−5° C.). One preferred bicomponent staple fiber employed in the practice of the embodiments disclosed herein is LMF50 bicomponent staple fibers commercially available from Huvis Corporation, Seoul, Republic of Korea, having a denier of about 4 and a length of about 6 mm. The sheath portion of the bicomponent fiber may also be comprised of other thermoplastic polymeric material, including polyalkylenes (e.g., polyethylenes, polypropylenes and the like) and polyamides (nylons, for example, nylon-6, nylon 6,6, nylon-6,12, and the like).

The bicomponent staple fibers will be present in the filtration media in an amount of 20 wt. % to about 80 wt. %, for example between about 25 wt. % to about 60 wt. %, or even about 30 wt. % to 60 wt % (+/−0.5 wt. %), based on the total weight of the fibers in the fibrous web.

### B. Synthetic Staple Fibers

The nonwoven fibrous web of the embodiments described herein will also comprise other synthetic staple fibers which include between about 20 wt. % to about 80 wt. %, for example between about 40 wt. % to about 75 wt. %, based on total weight of fibrous web, of thermoplastic staple fibers. Preferably, the thermoplastic staple fibers will be less than about 20 μm in average diameter, for example between about 2.5 μm to about 15 μm, with lengths between about 1 mm to about 24 mm, for example, between about 3 mm to about 12 mm.

The other synthetic staple fibers employed in the practice of the embodiments disclosed herein can be virtually any staple fiber formed of a thermoplastic polymeric material. For use as an engine oil filter media, the other synthetic fibers should have low water absorption, acid resistance, heat resistance, and compatibility with engine oil. Exemplary thermoplastic staple fibers therefore include polyesters (e.g., polyalkylene terephthalates such as polyethylene terephthalate (PET), polybutylene terephthalate (PBT) and the like), polyalkylenes (e.g., polyethylenes, polypropylenes and the like), polyacrylonitriles (PAN), and polyamides (nylons, for example, nylon-6, nylon 6,6, nylon-6,12, and the like). Preferred are PET fibers which exhibit good chemical and thermal resistance suitable for filtration end use applications.

In certain preferred forms, the nonwoven fibrous web will comprise a mixture of differently sized synthetic fibers. In this regard, the media may comprise a mixture of between about 20 wt. % to about 80 wt. %, based on total weight of the fibrous web, of at least one type of synthetic polymeric fibers having an average diameter of between about 2.5 μm to about 10 μm, and between about 30 wt. % to about 60 wt. %, based on total weight of the fibrous web, of a second type of synthetic polymer fibers having an average diameter of between about 10 μm to about 20 μm. The first type of synthetic fibers may have an average length of between about 1 mm to about 6 mm, while the second type of synthetic fibers may have an average length of between about 5 mm to about 24 mm.

The other synthetic staple fibers employed in the wet-laid fibrous media may also include between about 5 wt. % to about 30 wt. %, typically between 10 wt. % to about 20 wt. %, based on total weight of the fibrous web, of a regenerated cellulosic fiber, preferably lyocell staple fibers. The lyocell staple fibers may have an average diameter of about 25 μm or less, typically 15 μm or less, e.g., between about 10 μm to about 15 μm. The average length of the lyocell staple fibers is typically between about 1 mm to about 8 mm, or between about 2 mm to about 6 mm, or about 3 mm to about 4 mm. Preferred lyocell fibers are commercially available from Engineered Fibers Technology, LLC of Shelton, Conn. under the tradename TENCEL® lyocell fibers which have about 1.7 denier and about 4 mm staple length. Additionally, the other synthetic staple fibers employed in the wet-laid fibrous media may also include between about 5 wt. % to about 30 wt. % acrylic fibers and/or nylon fibers.

Glass microfibers may also optionally be present in admixture with the other synthetic fibers as previously described in amounts sufficient to improve efficiency of the fibrous media as a filter. Typically, the glass microfibers, if present, will be employed in amounts of 0-20 wt. %, typically less than about 10 wt. %, based on total weight of the fibrous web. Glass microfibers having an average fiber diameter of between about 0.2 μm to about 5 μm, typically between about 0.5 μm to about 2.5 μm±about 0.1 μm, may be employed. Preferred glass microfibers for the fibrous media of the embodiments described herein may be commercially obtained as C04 glass fibers (average fiber diameter of 0.5 μm), C06 glass fibers (average fiber diameter of 0.65 μm) and C26 glass fibers (average fiber diameter of 2.6 μm) from Lauscha Fiber International of Summerville, S.C.

### C. Optional Components

Additives conventionally employed in wet-laid filtration media, such as for example, wet strength additives, optical brighteners, fiber retention agents, colorants, separation aides (e.g., silicone additives and associated catalyzers), fire or flame retardants (e.g., in the form of particulates or fibers) and the like may also be present in the fibrous web. If present, these additives may be included in amounts of up to about 30 wt. %, preferably up to about 20 wt. %, for example between about 1 wt. % to about 20 wt. %, based on total weight of the fibrous web. If flame retardant fibers are incorporated into the fibrous web, the flame retardant fibers can be used between about 40 to about 80 wt. %, based on the total weight of the fibrous web.

### D. Methods of Making

The nonwoven fibrous web described herein may be made by any conventional “wet-laid” paper-making technology. Thus, for example, predetermined amounts of the sheath-core bicomponent staple fibers (along with any optional components, such as the glass fibers, basic thermoplastic fibers and/or additives), the other synthetic staple fibers and water may be placed in a pulper or beater. The fibers are mixed and dispersed by the pulper or beater evenly in the water to form a slurry batch. Some mechanical work can also be performed on the fibers to affect physical parameters, such as permeability, surface properties and fiber structure. The slurry batch may thereafter be transferred to a mixing chest where additional water is added and the fibers are homogenously blended. The blended slurry may then be transferred to a machine chest where one or more slurry batches can be combined, allowing for a transfer from a batch to a continuous process. Slurry consistency is defined and maintained by agitation to assure even dispersion of fibers. In this regard, the slurry may optionally be passed through a refiner to adjust physical parameters.

The slurry is then transferred to a moving wire screen where water is removed by means of gravity and suction. As water is removed, the fibers form into a nonwoven fibrous web or sheet having characteristics determined by a number of process variables, including for example, the slurry flow rate, machine speed, and drainage parameters. The formed web may optionally be compressed while still wet so as to compact the paper and/or modify its surface characteristics. The wet fibrous web is then moved through a drying section comprised of heated rollers (or “cans” in art parlance) where most of the remaining entrained water is removed. The dried fibrous web may then have a binder resin applied by any conventional means, such as dipping, spray coating, roller (gravure) application and the like. Heat may then subsequently be applied to dry the web.

The nonwoven fibrous web may then be taken up on a roll for further processing into finished sheet or passed directly to a calendering section comprised of at least one pair, preferably a series of two pairs, of opposed calendering rolls as shown in FIG. 10. The calendering rolls operate so as to press (consolidate) the mass of nonwoven wet-laid fibers in the sheet to form the nonwoven fibrous web of the filtration media as disclosed herein. In preferred forms, the calendering rolls will operate so as to press the nonwoven fibrous web at calendering pressures of about 1 kN/m to about 150 kN/m and calendering temperatures of 110° C. to about 250° C. sufficient to allow the sheath of the bicomponent staple fiber component to melt and form a bond with the other synthetic fiber components in the nonwoven web. Calendering machine line speed can be selected to be between about 1 m/min to about 50 m/min. Such calendering machine line speeds and elevated temperatures/pressures as herein described results in hot area calendering of the fibrous web.

The calendering rolls do not point bond the nonwoven fibrous web. Instead, the calendering rolls impart substantially uniform pressure and temperature across the entire surface area of the web in the manner described hereinabove so as to evenly calender the web (i.e., area-calendering). Such hot area-calendering thereby causes a substantial (if not the entire) part of the lower melting sheath polymer of the bicomponent staple fibers in the nonwoven web to melt and thereby bond the remaining thermoplastic core component of the bicomponent staple fibers with one another and with the other synthetic staple fibers in the web.

The nonwoven fibrous web may then be passed to an embossing section where one side of the fibrous web is embossed. The embossing section comprises a pair of opposing rolls, one roll preferably of a rigid material such as steel and having an embossing pattern therein, and the second roll being of a material such as silicone rubber and having no embossing pattern therein. The embossing pattern may take many forms with preferred examples including a striped pattern, for example vertical stripes, horizontal stripes, or diagonal stripes. Other patterns such as a diamond pattern may also be used in some embodiments. The fibrous web is fed to the embossing section with one of the sides oriented in the direction of the first roll having the embossing pattern such that the embossing is applied to one side. The embossed side of the fibrous web is positioned on the downstream side of a filter element comprising said fibrous web.

The embossing will occur at a temperature and pressure, with the embossing machine operating at an embossing machine speed sufficient to apply the embossing to the one side of the fibrous web. The embossing temperature may be in a range of between 150 and 200° C. The embossing pressure may be in a range of between 1 and 20 kgf/cm. The embossing machine speed may be in a range of about 1 to 20 m/min.

The resulting nonwoven fibrous web may be employed as is in the form of filtration media or may be plied with additional fibrous media, for example pre-formed fibrous layers or a web formed of multiple layers in the wet-laid process. When the multiple fibrous web layers provide the filtration media, then the hot area calendered fibrous web layer of the embodiments disclosed herein is preferably—but not required to be—positioned so as to be on the downstream side of the filter element. By way of example, the fibrous web can be laminated to a membrane formed of expanded polytetrafluoroethylene (ePTFE) having a basis weight of, e.g., about 1 to about 50 g/m², or a multiple-layer (e.g., two or three fibrous web layers) filtration media could be provided whereby one of such multiple layers is a hot area calendered fibrous web layer according to the embodiments disclosed herein.

The inventive fibrous filtration media will be self-supporting when pleated and formed into a filter element. The filter element according to the present disclosure is particularly suitable for use as an oil filter, especially in lube oil systems. The filter element comprising the fibrous filtration media is designed so that the side comprising the embossing is positioned on the downstream side of the filter element.

### E. Media Properties

The resulting hot area-calendered fibrous web will exhibit a high dry and wet burst strength of greater than 5 bar, typically greater than 10 bar, and more preferably greater than 12 bar or even greater than 15 bar in some embodiments. After hot oil aging, the hot area-calendered fibrous web continues to exhibit a high dry burst strength of greater than 5 bar, usually greater than 10 bar. These high dry and wet burst strengths are achievable by virtue of the hot area calendering as herein described melting the sheaths of the bicomponent staple fibers through the web so as to cause the remaining core component of the bicomponent staple fibers and the synthetic staple fibers to bond one to another throughout the fibrous web.

The density of the fibrous web will typically be greater than about 0.20 g/cm³, for example greater than about 0.30 g/cm³

The Pore Size Range of the fibrous web is preferably less than 30 μm; typically 25 μm or less, more typically 22 μm or less, and in some embodiments 20 μm or less. The Minimum Pore Size is preferably 40 μm or less; typically 25 μm or less, or more typically 22 μm or less. In some embodiments, the Mean Flow Pore Size can be 60 μm or less, 40 μm or less, typically 35 μm or less, for example 30 μm or less. The maximum pore size can be 70 μm or less, 50 μm or less, typically 45 μm or less, for example, 40 μm or less.

In one embodiment, the media is designed to have greater than 99% particle removal efficiency for 20 micron particles. In a second embodiment, the media is designed to have greater than 99% particle removal efficiency for 10 micron particles. In a third embodiment, the media is designed to have between 50 and 70% particle removal efficiency for 20 micron particles.

The present invention will be further illustrated by the following non-limiting examples thereof.

### EXAMPLES

### 1. Test Methods

The following test methods were employed to obtain the data reported in the Table below.

Pore Size: Pore size (μm) was determined by the American Society of Testing and Materials (ASTM) Standard 316-03 (2011) (incorporated fully by reference herein). The minimum, maximum and mean flow pore sizes, and the number of pores of the media examples below were measured with Porometer 3G produced by Quantachrome Instruments (1900 Corporate Drive Boynton Beach, Fla. 33426 USA) with the reported pore size and pore number data being an average of two samples, one tested on each side of the media. (i.e. wire side and felt side in the case of wet-laid media).

The pore size and pore number data are measured using a technique known as capillary flow porometry. The sample is first wetted with a wetting fluid such that all the pores in the sample are filled. A nonreacting gas of increasing pressure is applied to one side of the wet sample to displace the liquid from the pores. The gas pressure and gas flowrate downstream of the sample are measured and plotted for the wet sample. After the sample is dry, the test is repeated to plot a gas flow vs. the applied pressure curve for the dry sample. Using such capillary porometry technique, the “maximum pore size”, “minimum pore size” and “mean flow pore size” can be determined.

Maximum Pore Size: The gas pressure using the capillary flow porometry technique described hereinabove at which air flow through the media is first detected (i.e. the pressure at which the bubbles first begin to flow) is used to calculate the maximum pore size.

Minimum Pore Size is determined from the pressure at which the wet flow rate curve merges with dry curve using the capillary flow porometry technique described hereinabove.

Mean Flow Pore Size is the pore diameter at which the flow through a wetted medium is 50% of the flow through the dry medium at the same pressure drop using the capillary flow porometry technique described hereinabove.

Pore Size Range is defined as the difference between the Maximum Pore Size and the Minimum Pore Size (i.e. Pore Size Range=Maximum Pore Size−Minimum Pore Size).

Caliper: The caliper (thickness) of the media was measured according to the International Organization for Standardization (ISO) Standard ISO 534 (2011), “Paper and board-Determination of thickness, density and specific volume” (incorporated fully by reference herein).

Burst Strength: The pressure required to rupture a media sample when either dry (“dry burst strength”) or wet (“wet burst strength”) was measured according to ISO Standard 2758 (2014), “Paper-Determination of bursting strength” (incorporated fully by reference herein). The dry burst strength of a media sample after hot oil aging was also measured. The sample was first soaked in hot oil at 150° C. for 168 hours. The media sample was then removed, cooled for about 5 minutes, and excess oil was blotted from the sample. Then the moisture free sample was tested according to ISO Standard 2758 (2014). Results are reported in kilogram force per square meter at media rupture and then converted to the units of bar.

MD Stiffness: Stiffness of the media in the machine direction (MD) was determined according to TAPPI T 489 om-92 using a Gurley bending resistance tester MOD 4171D (Gurley Precision Instruments).

Void Ratio: The void ratio was determined by the following procedure: A 40 mm×40 mm dry test piece of the media having an initial weight (w1) was placed in a beaker with 200 cc of n-butyl alcohol and thereafter positioned in a desiccator which is evacuated until no bubbles emanating from the test piece were visibly observed. The test piece was removed from the n-butyl alcohol in the beaker and weighed immediately upon removal to obtain an initial weight (w2) and the reweighed after 30 seconds of removal to obtain a final wet weight (w3). The void ratio (%) was then calculated by the following formula: void ratio (%)=(w3−w1)/(w3−w2)×100.

Dust Holding Capacity and Particle Removal Efficiency: Dust holding capacity and particle removal efficiency were measured according to ISO Standard 4548-12 (2017), “Methods of test for full-flow lubricating oil filters for internal combustion engines—Part 12: Filtration efficiency using particle counting and contaminant retention capacity” (incorporated fully by reference herein) using a Multipass system.

### 2. Materials

The following materials were employed:

LMF50: 4 denier, 6 mm length (4 De*6 mm) staple bicomponent low melting fibers commercially available from Huvis Corporation, Seoul, Republic of Korea.

PET: Polyethylene terephthalate fibers were employed having 1.4 denier, 12 mm length (1.4 De*12 mm) commercially available from Toray Industries, Tokyo, Japan, 0.5 denier, 5 mm length (0.5 De*5 mm) commercially available from Huvis Corporation, and 0.3 dtex, 5 mm (0.3 Dt*5 mm) commercially available from Teijin Ltd., Tokyo, Japan.

### 3. Media Examples

The sample media below was produced by a wet-laid process noted above and subject to area-calendering and embossing as noted above.

Sample Media: A base substrate was prepared by the method described above to form a 100% synthetic fiber wet-laid nonwoven media comprising 30 wt. % LMF50 4 De*6 mm bicomponent staple fibers and a mixture of PET staple fibers consisting of 30 wt. % PET 0.5 De*5 mm staple fibers (Huvis), 20 wt. % PET 1.4 De*12 mm (Toray), and 20 wt. % PET 0.3 dt*5 mm (Teijen). The base substrate was calendered at a calendering nip pressure of 75 kN/m and a calendering temperature of 210° C. to obtain a calendered wet-laid nonwoven media having a basis weight of 210 g/m², a flat sheet caliper of 0.63 mm, and an air permeability of 26 cfm. The calendered wet-laid nonwoven media was embossed at an embossing temperature of 160° C., an embossing pressure of 3 kgf/cm, and an embossing machine speed of 3 m/min to obtain an embossed calendered wet-laid nonwoven media having a basis weight of 210 g/m², a flat sheet caliper of 0.63/0.48 mm (0.48 mm being the caliper measurement in the recessed area of the media), and an air permeability of 24 cfm.

### 4. Experimental Results

### 4.1 Experimental Result 1

The media examples described above was tested to determine pore size data (mean flow and maximum pore sizes). In addition the media example was tested for dry burst strength, density, and stiffness. The data appears in Table 1 below. In Table 1, Sample B represents an inventive media after calendaring and Sample C represents an inventive media after calendaring and embossing while Samples A represents a comparative media before calendaring or embossing.

TABLE 1
Physical properties of the inventive media

| Physical | | | | |
|---|---|---|---|---|
| Properties | unit | Sample A | Sample B | Sample C |
| Density | g/cm³ | 0.12 | 0.33 | 0.33/0.44 |
| | | | | at the |
| | | | | recessed area |
| Burst strength | Kg/cm² | 5.9 | 18.6 | 19.7 |
| (Dry) | | | | |
| Stiffness (MD) | mg | — | 3300 | 2667 |
| Max pore size | μm | 99.2 | 42.0 | 44.0 |
| Mean pore size | μm | 86.0 | 34.0 | 36.5 |

The above data show that the inventive media has a much higher density than the comparative media. The difference is even higher at the recessed area of the embossed sample.

### 4.2 Experimental Result 2

Filtration performance tests were conducted using filter elements made containing the inventive media, described above as Sample C. The media was made into an engine oil filter of similar design to that used in a Jeep Grand Cherokee (Part No. 68191349AA). The filter elements were cylindrical in shape containing the inventive media folded into pleats with a pleat width of 1.2 cm and a pleat length of about 11.6 cm.

While the standard filter is designed to have a total of 55 pleat peaks and leading to a filtration area of 1,531.2 cm², additional tests were run with filters having different numbers of pleat peaks. Specifically, tests were run with filters having 47 pleat peaks (reducing the filtration area) and 65 pleat peaks (increasing the filtration area).

Each sample was tested before and after hot oil aging. Hot oil aging was achieved by placing the filter element into engine oil at a temperature of 150° C. and maintaining the filter element in the engine oil for 120 hours.

A comparative base substrate was prepared by the method described above to form a 100% synthetic fiber wet-laid nonwoven media comprising 30 wt. % LMF50 4 De*6 mm bicomponent staple fibers and a mixture of PET staple fibers consisting of 57.1 wt. % PET 0.3 De*5 mm staple fibers and 12.9 wt. % PET 0.06 dtex*3 mm.

The comparative media was then impregnated with 13 wt. % thermoset acrylic binder resin in order to obtain the required stiffness for pleating. The comparative media was not calendered or embossed. The comparative media was not self-supporting and required an additional wire mesh layer when pleated into a filter element. Due to the presence of wire backing, the comparative media was much thicker and only 47 pleat peaks could be fit into the housing.

The filter elements were tested with a fluid flow rate of 20 L/min using ISO Medium Test dust injected at a particle injection flow of 250 mL/min, BUGL (Basic Upstream Gravimetric Level)=15 mg/L. The test was stopped once the filter elements reached terminal pressure drop of 100 kPa. The data is provided in Table 2 below.

TABLE 2
Filter Element Efficiency of the Inventive Media

| | | Overall Efficiency (% at specified μm) | | | | | | | | | |
|---|---|---|---|---|---|---|---|---|---|---|---|
| Sample | Description | 4 μm | 5 μm | 6 μm | 7 μm | 8 μm | 9 μm | 10 μm | 12 μm | 15 μm | 17 μm |
| 1 | Filter Element- | 21.9 | 28.4 | 36.8 | 45.4 | 53.9 | 62.3 | 70.6 | 83.9 | 94.4 | 97.6 |
| | no wire backing, | | | | | | | | | | |
| | inventive media | | | | | | | | | | |
| | 47 pleat peaks | | | | | | | | | | |
| 2 | Filter Element- | 22.5 | 29.2 | 37.6 | 46.7 | 55.4 | 63.9 | 71.9 | 84.8 | 94.9 | 97.9 |
| | no wire backing, | | | | | | | | | | |
| | inventive media | | | | | | | | | | |
| | 55 pleat peaks | | | | | | | | | | |
| 3 | Filter Element- | 20.7 | 26.4 | 33.7 | 41.7 | 49.5 | 57.7 | 65.7 | 79.4 | 92.4 | 96.5 |
| | no wire backing, | | | | | | | | | | |
| | inventive media | | | | | | | | | | |
| | 65 pleat peaks | | | | | | | | | | |
| 4 | Filter Element- | 13.3 | 17.2 | 22.9 | 30 | 37.7 | 46.3 | 55.8 | 73.5 | 91.3 | 96.3 |
| | wire backing, | | | | | | | | | | |
| | comparative | | | | | | | | | | |
| | media | | | | | | | | | | |
| | 47 pleat peaks | | | | | | | | | | |

| | | | | | | | | Apparent | Life |
|---|---|---|---|---|---|---|---|---|---|
| | | Overall Efficiency (% at specified μm) | | | | | | Capacity | Time |
| Sample | Description | 20 μm | 25 μm | 30 μm | 35 μm | 40 μm | 50 μm | (g) | (min) |
| 1 | Filter Element- | 99.5 | 100 | 100 | 100 | 100 | 100 | 5.661 | 0:19:31 |
| | no wire backing, | | | | | | | | |
| | inventive media | | | | | | | | |
| | 47 pleat peaks | | | | | | | | |
| 2 | Filter Element- | 99.5 | 100 | 100 | 100 | 100 | 100 | 5.981 | 0:20:36 |
| | no wire backing, | | | | | | | | |
| | inventive media | | | | | | | | |
| | 55 pleat peaks | | | | | | | | |
| 3 | Filter Element- | 99 | 100 | 100 | 100 | 100 | 100 | 8.606 | 0:30:01 |
| | no wire backing, | | | | | | | | |
| | inventive media | | | | | | | | |
| | 65 pleat peaks | | | | | | | | |
| 4 | Filter Element- | 99.3 | 100 | 100 | 100 | 100 | 100 | 4.988 | 0:17:38 |
| | wire backing, | | | | | | | | |
| | comparative | | | | | | | | |
| | media | | | | | | | | |
| | 47 pleat peaks | | | | | | | | |

The filter elements having increased numbers of pleat peaks had a longer life time. It is believed that the invented media having a higher density in the embossed area can have an increased number of pleat peaks and achieve a longer life time.

The filter element after hot oil aging also showed improved life time in comparison to the comparative examples. The filter element containing the comparative media required a wire backing. Due to the wire, only 47 pleat peaks of the comparative media could be fit inside the filter housing. By comparison, the inventive filter media is more dense and does not require a wire backing. So additional pleats could be fit into the filter housing resulting in a filter element having a higher filtration area. In fact, the life of the filter containing the inventive media can be extended to almost double that of the comparative filter with the wire backing.

### 4.3 Experimental Result 3

Additional tests were conducted on the inventive filter media (Sample C) with a fluid flow rate of 4 L/min using ISO Medium Test dust injected at a particle injection flow of 250 mL/min, BUGL (Basic Upstream Gravimetric Level)=15 mg/L. The test was stopped once the filter media reached terminal pressure drop of 78.5 kPa. The data is provided in Table 3 below with reference to Sample 7. The data provided in Table 3 is for a filtration media prior to pleating and hot oil aging.

TABLE 3
Filtration Performance of the Inventive Media

| | Overall Efficiency (% at specified μm) | | | | | | | | |
|---|---|---|---|---|---|---|---|---|---|
| Sample | 4 μm | 5 μm | 6 μm | 7 μm | 8 μm | 9 μm | 10 μm | 12 μm | 15 μm |
| 7 | 7.0 | 9.7 | 13.9 | 19.3 | 24.9 | 31.2 | 38.6 | 53.6 | 75.2 |

| | | | | | | | | Apparent |
|---|---|---|---|---|---|---|---|---|
| | Overall Efficiency (% at specified μm) | | | | | | | Capacity |
| Sample | 17 μm | 20 μm | 25 μm | 30 μm | 35 μm | 40 μm | 50 μm | (g) |
| 7 | 85.2 | 94.6 | 99.4 | 100.0 | 100.0 | 100.0 | 100.0 | 11.93 |

The results of show that the inventive filter media provides effective overall efficiency and capacity at multiple fluid flow rates.

Finally, the inventive media was tested for burst strength and stiffness before and after hot-oil aging. Hot oil aging was achieved by placing the filter element into engine oil at a temperature of 150° C. and maintaining the filter element in the engine oil for 7 days (168 hours). The results appear in Table 4 below.

TABLE 4

| | Before Hot | After Hot |
|---|---|---|
| | Oil Aging | Oil Aging |
| Dry Burst Strength | 17.8 | 11.3 |
| (filter element) - kg/cm² | | |
| Dry Burst Strength | 18.9 | 13.7 |
| (filter media) - kg/cm² | | |
| MD Stiffness | 2341 | 2963.3 |
| (filter media) - mg | | |

The data shows that, while the dry burst strength decreases for the inventive media, after hot oil aging, stiffness actually increases. While the dry burst strength decreases upon exposure to hot oil, the aged media still has a very high dry burst strength above 10 bar. It is believed that the increase in stiffness achieved by the inventive media may contribute to the media's aging resistance and hence better filtration performance in hot oil.

It has been determined that the high density of the media combined with the calendaring allows the media to be self-supporting without the need for co-pleating or a backing such as a wire mesh. The calendaring and increased density result in a much stronger media with higher burst strength and stiffness.

It has also been determined that the embossing allows the media to resist aging effects after exposure to hot oil such as that found in an internal combustion engine. That is to say that the media retains its shape and embossing pattern. Filter elements formed from the embossed inventive media keep their pleat shape without any pleat collapse or bulging. The embossing on one side also creates additional channels for oil flow. All of which allows for the inventive filter media to have a slower pressure drop increase and thus a longer life than previous filter media containing high levels of synthetic fibers and corrugated by conventional methods. Such previous filter media cannot keep their corrugation after hot oil aging due to the shrinkage of the synthetic fibers, especially in low density media.

### Embodiments

Embodiments of the invention include i.a. the following:
1. A fibrous filtration media comprising a wet-laid, hot area-calendered nonwoven fibrous web comprising:
   from about 20 wt. % to about 80 wt. %, based on total weight of the fibrous web, bicomponent staple fibers dispersed through the fibrous web, and other synthetic staple fibers, wherein
   the fibrous web has a density greater than about 0.20 g/cm³, and exhibits a dry burst strength of greater than 5 bar.
2. The fibrous filtration media according to embodiment 1, wherein the fibrous web has an MD stiffness of at least 2000 mg after hot oil aging.
3. The fibrous filtration media according to embodiment 1 or 2, wherein the fibrous web has a dry burst strength of greater than about 10 bar.
4. The fibrous filtration media according to any of embodiments 1 to 3, wherein the fibrous web has a density greater than about 0.30 g/cm³.
5. The fibrous filtration media according to any of embodiments 1 to 4, wherein one side of the fibrous web comprises an embossing.
6. The fibrous filtration media according to any of embodiments 1 to 5 which comprises between 0 and 20 wt. %, based on total weight of the fibrous web, of glass fibers.
7. The fibrous filtration media according to any of embodiments 1 to 6, wherein the other synthetic staple fibers comprise a mixture of at least two different types of synthetic fibers.
8. The fibrous filtration media according to any of embodiments 1 to 7, wherein the other synthetic staple fibers comprise between about 5 wt. % to about 30 wt. % based on total weight of the fibrous web, of regenerated cellulosic fibers.
9. The fibrous filtration media according to any of embodiments 1 to 8, wherein the filtration media further comprises at least one additive selected from the group consisting of wet strength additives, optical brighteners, fiber retention agents, colorants, fuel-water separation aides, and flame or fire retardants.
10. The fibrous filtration media according to any of embodiments 1 to 9, wherein the other synthetic staple fibers are forms of a polymer selected from the group consisting of polyethylene terephthalate (PET), polybutylene terephthalate (PBT), polyethylene (PE), polypropylenes (PP), nylon-6, nylon 6,6, nylon-6, 12, and combinations thereof.
11. The fibrous filtration media according to any of embodiments 1 to 10, wherein the other synthetic staple fibers are present at a level of at least 20 wt. % based on total weight of the fibrous web.
12. The fibrous filtration media according to any of embodiments 1 to 11, wherein the bicomponent staple fibers are present at a level in the range of between about 30 wt. % to about 60 wt. % based on total weight of the fibrous web.
13. The fibrous filtration media according to any of embodiments 1 to 12, wherein the bicomponent staple fibers are sheath-core bicomponent staple fibers.
14. The fibrous filtration media according to embodiment 13, wherein the sheath and core of the bicomponent staple fibers are formed of polyethylene terephthalate (PET), wherein the PET forming the sheath has a melting temperature which is less than that of the PET forming the core.
15. The fibrous filtration media according to any of embodiments 1 to 14, wherein the fibrous web has a Pore Size Range of 30 μm or less.
16. The fibrous filtration media according to any of embodiments 1 to 15, wherein the filtration media has a particle removal efficiency of at least 50% at 20 microns.
17. A filter element comprising the filtration media of any of embodiments 1 to 16 for use in hot oil filtration.
18. The filter element according to embodiment 17, wherein one side of the filtration media comprises an embossing, and the one side of the filtration media comprising the embossing is positioned on a downstream side of the filter element.
19. A method of making a fibrous web comprising:
   a. forming a wet-laid fibrous web from an aqueous fibrous slurry comprising synthetic staple fibers and from about 20 wt. % to about 80 wt. %, based on total weight of the fibrous web, of sheath-core bicomponent staple fibers;
   b. subjecting the wet-laid fibrous web from step a to hot area calendering to melt the sheath of the bicomponent staple fibers so as to bond the synthetic staple fibers one to another and achieve a fibrous web having a density greater than about 0.20 g/cm³, and a dry burst strength of greater than 5 bar.
20. The method according to embodiment 19, wherein step b is practiced at a calendering pressure condition of between about 1 kN/m to about 150 kN/m and a calendering temperature condition of between about 110° C. to about 250° with a calendering line speed of between about 1 m/min to about 50 m/min.
21. The method according to any of embodiments 19 to 20, further comprising:
   c. subjecting one side of the fibrous web to embossing.
22. The method according to embodiment 21, wherein step c is practiced at an embossing temperature condition of between about 150 and 200° C., and at an embossing pressure condition of between about 1 and 20 kgf/cm, and at an embossing machine speed of about 1 to 20 m/min

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope thereof.

What is claimed is:

1. A fibrous filtration media comprising a wet-laid, hot area-calendered nonwoven fibrous web comprising:
from about 20 wt. % to about 80 wt. %, based on total weight of the fibrous web, bicomponent staple fibers dispersed through the fibrous web; and
other synthetic staple fibers, wherein
the fibrous web has a density greater than about 0.20 g/cm³, and exhibits a dry burst strength of greater than 5 bar.

2. The fibrous filtration media according to claim 1, wherein the fibrous web has an MD stiffness of at least 2000 mg after hot oil aging.

3. The fibrous filtration media according to claim 1, wherein the fibrous web has a dry burst strength of greater than about 10 bar.

4. The fibrous filtration media according to claim 1, wherein the fibrous web has a density greater than about 0.30 g/cm³.

5. The fibrous filtration media according to claim 1, wherein one side of the fibrous web comprises an embossing.

6. The fibrous filtration media according to claim 1 which comprises between 0 and 20 wt. %, based on total weight of the fibrous web, of glass fibers.

7. The fibrous filtration media according to claim 1 wherein the other synthetic staple fibers comprise a mixture of at least two different types of synthetic fibers.

8. The fibrous filtration media according to claim 1, wherein the other synthetic staple fibers comprise between about 5 wt. % to about 30 wt. % based on total weight of the fibrous web, of regenerated cellulosic fibers.

9. The fibrous filtration media according to claim 1, wherein the filtration media further comprises at least one additive selected from the group consisting of wet strength additives, optical brighteners, fiber retention agents, colorants, fuel-water separation aides, and flame or fire retardants.

10. The fibrous filtration media according to claim 1, wherein the other synthetic staple fibers are forms of a polymer selected from the group consisting of polyethylene terephthalate (PET), polybutylene terephthalate (PBT), polyethylene (PE), polypropylenes (PP), nylon-6, nylon 6,6, nylon-6,12, and combinations thereof.

11. The fibrous filtration media according to claim 1, wherein the other synthetic staple fibers are present at a level of at least 20 wt. % based on total weight of the fibrous web.

12. The fibrous filtration media according to claim 1, wherein the bicomponent staple fibers are present at a level in the range of between about 30 wt. % to about 60 wt. % based on total weight of the fibrous web.

13. The fibrous filtration media according to claim 1, wherein the bicomponent staple fibers are sheath-core bicomponent stable fibers.

14. The fibrous filtration media according to claim 13, wherein the sheath and core of the bicomponent staple fibers are formed of polyethylene terephthalate (PET), wherein the PET forming the sheath has a melting temperature which is less than that of the PET forming the core.

15. The fibrous filtration media according to claim 1, wherein the fibrous web has a Pore Size Range of 30 μm or less.

16. The fibrous filtration media according to claim 1, wherein the filtration media has a particle removal efficiency of at least 50% at 20 microns.

17. A filter element comprising the filtration media of claim 1 for use in hot oil filtration.

18. The filter element according to claim 17, wherein one side of the filtration media comprises an embossing, and the one side of the filtration media comprising the embossing is positioned on a downstream side of the filter element.

19. A method of making a fibrous web comprising:
a. forming a wet-laid fibrous web from an aqueous fibrous slurry comprising synthetic staple fibers and from about 20 wt. % to about 80 wt. %, based on total weight of the fibrous web, of sheath-core-bicomponent staple fibers;
b. subjecting the wet-laid fibrous web from step a to hot area calendering to melt the sheath of the bicomponent staple fibers so as to bond the synthetic staple fibers one to another and achieve a fibrous web having a density greater than about 0.20 g/cm³, and a dry burst strength of greater than 5 bar.

20. The method according to claim 19, wherein step b is practiced at a calendering pressure condition of between about 1 kN/m to about 150 kN/m and a calendering temperature condition of between about 110° C. to about 250° C. with a calendering line speed of between about 1 m/min to about 50 m/min.

21. The method according to claim 19, further comprising:
c. subjecting one side of the fibrous web to embossing.

22. The method according to claim 21, wherein step c is practiced at an embossing temperature condition of between about 150 and 200° C., and at an embossing pressure condition of between about 1 and 20 kgf/cm, and at an embossing machine speed of about 1 to 20 m/min.
